(19) United States
(12) Patent Application Publication
(10) Pub. No.: US 2026/0273342 A1
(43) Pub. Date: Sep. 17, 2026

(54) SYSTEM FOR EVALUATING MOTION IN SPORTS

(71) Applicant: SoftBank Group Corp., Tokyo (JP)

(72) Inventor: Yuji IKEGAWA, Tokyo (JP)

(21) Appl. No.: 19/561,549

(22) Filed: Mar. 10, 2026

Related U.S. Application Data
(60) Provisional application No. 63/771,003, filed on Mar. 13, 2025.

(51) Int. Cl. A63B 24/00; A63B 71/06

(52) U.S. Cl. CPC A63B 24/0075; A63B 71/0622; A63B 2024/0015; A63B 2024/0068; A63B 2071/0636; A63B 2214/00; A63B 2220/05; A63B 2220/806

(57) ABSTRACT

A system that supports the optimization of motion and improvement of skills in sports. A user captures their own motion using a smartphone, performs motion analysis within the terminal, and generates motion data including joint information for 200 locations. This data is transmitted to a server, which generates an ideal form based on the motion of a professional athlete. The generated ideal form is visualized on the terminal, and the user can compare it with their own motion. Furthermore, the server proposes an individual practice menu based on the user's motion data and provides specific improvement methods. This system includes a motion analysis unit, an ideal form generation unit, a projection display unit, a communication unit, a database unit, and a practice menu generation unit.

### CROSS-REFERENCE TO RELATED APPLICATIONS

This application is based upon and claims the benefit of priority from U.S. Provisional Patent Application No. 63/771,003, filed on Mar. 13, 2025, the entire contents of which are incorporated herein by reference.

### BACKGROUND

Japanese Unexamined Patent Publication No. 2022-180282 discloses a method, which is a persona chatbot control method performed by at least one processor, the method including a step of receiving a user utterance, a step of adding the user utterance to a prompt including an instruction sentence associated with a description regarding a character of a chatbot, a step of encoding the prompt, and a step of inputting the encoded prompt to a language model to generate a chatbot utterance responding to the user utterance.

### SUMMARY

A problem to be solved by this disclosure is to provide specific guidelines for optimizing motion and improving performance in sports.

Conventionally, improving sports skills has required specialized coaching and long-term training, and it has been difficult for individual athletes to obtain specific methods for objectively evaluating and improving their own motions. In addition, while imitating the motions of professional athletes is effective for learning an ideal form, there has been a lack of visual and specific means to achieve this.

A user's sports motion is analyzed in detail by capturing the motion using a smartphone and analyzing the motion utilizing AI technology, and an ideal form is generated using the motion of a professional athlete as a benchmark, thereby enabling the user to directly compare their own motion with the ideal form and visually confirm points for improvement. In addition, by proposing a practice menu based on the ideal form, the user can obtain specific practice methods and can efficiently improve their skills.

This makes it possible for individual athletes to objectively evaluate their own motions, provides specific guidelines and practice methods for learning an ideal form based on the motions of professional athletes, and can improve sports performance. Therefore, a new approach for optimizing motion and improving skills in sports is provided.

Disclosed herein is a system including a motion analysis unit, an ideal form generation unit, and a projection display unit. The motion analysis unit analyzes a sports motion captured by a user using a smartphone and generates detailed motion data including joint information for 200 locations. This motion data precisely digitizes the user's motion and enables objective evaluation of the motion by quantifying the position and movement trajectory of each joint.

The ideal form generation unit generates an ideal form based on the motion data obtained by the motion analysis unit, using the motion of a professional athlete as a benchmark. In this generation process, the motion data of the professional athlete and the motion data of the user are compared to identify points for improvement in the user's motion. This allows the user to compare their own motion with the ideal form and specifically understand which parts should be improved.

The projection display unit visualizes the ideal form generated by the ideal form generation unit as a virtual human motion and projects it in front of the user. This visualization enables the user to visually confirm the ideal motion and directly compare it with their own motion. This allows the user to visually understand the ideal form and efficiently improve their skills.

In this way, specific guidelines and means for a user to optimize motion and improve performance in sports are provided.

### BRIEF DESCRIPTION OF THE DRAWINGS

FIG. 1 is a conceptual diagram illustrating an example of a configuration of a data processing system according to a first embodiment.

FIG. 2 is a conceptual diagram illustrating an example of main functions of a data processing apparatus and a smart device according to the first embodiment.

FIG. 3 is a conceptual diagram illustrating an example of a configuration of a data processing system according to a second embodiment.

FIG. 4 is a conceptual diagram illustrating an example of main functions of a data processing apparatus and smart glasses according to the second embodiment.

FIG. 5 is a conceptual diagram illustrating an example of a configuration of a data processing system according to a third embodiment.

FIG. 6 is a conceptual diagram illustrating an example of main functions of a data processing apparatus and a headset-type terminal according to the third embodiment.

FIG. 7 is a conceptual diagram illustrating an example of a configuration of a data processing system according to a fourth embodiment.

FIG. 8 is a conceptual diagram illustrating an example of main functions of a data processing apparatus and a robot according to the fourth embodiment.

FIG. 9 illustrates an emotion map on which a plurality of emotions are mapped.

FIG. 10 illustrates an emotion map on which a plurality of emotions are mapped.

FIG. 11 is a flowchart illustrating an example of a method for evaluating motion in sports.

### DETAILED DESCRIPTION

Hereinafter, example systems according to the technology of the present disclosure will be described with reference to the accompanying drawings.

First, terms used in the following description will be described.

In the following embodiments, a processor with a reference sign (hereinafter, simply referred to as a “processor”) may be one arithmetic device or may be a combination of a plurality of arithmetic devices. Also, the processor may be one type of arithmetic device or may be a combination of a plurality of types of arithmetic devices. Examples of the arithmetic device include a CPU (Central Processing Unit), a GPU (Graphics Processing Unit), a GPGPU (General-Purpose computing on Graphics Processing Units), an APU (Accelerated Processing Unit), and the like.

In the following embodiments, a RAM (Random Access Memory) with a reference sign is a memory in which information is temporarily stored, and is used as a work memory by a processor.

In the following embodiments, a storage with a reference sign is one or more non-volatile storage devices that store various programs, various parameters, and the like. Examples of the non-volatile storage device include a flash memory (SSD (Solid State Drive)), a magnetic disk (for example, a hard disk), or a magnetic tape, and the like.

In the following embodiments, a communication I/F (Interface) with a reference sign is an interface including a communication processor, an antenna, and the like. The communication I/F manages communication among a plurality of computers. An example of a communication standard applied to the communication I/F includes a wireless communication standard including 5G (5th Generation Mobile Communication System), Wi-Fi (registered trademark), or Bluetooth (registered trademark), and the like.

In the following embodiments, “A and/or B” is synonymous with “at least one of A and B”. That is, “A and/or B” means that it may be A only, B only, or a combination of A and B. Also, in the present specification, when three or more matters are expressed by being connected with “and/or”, the same concept as “A and/or B” is applied.

### First Embodiment

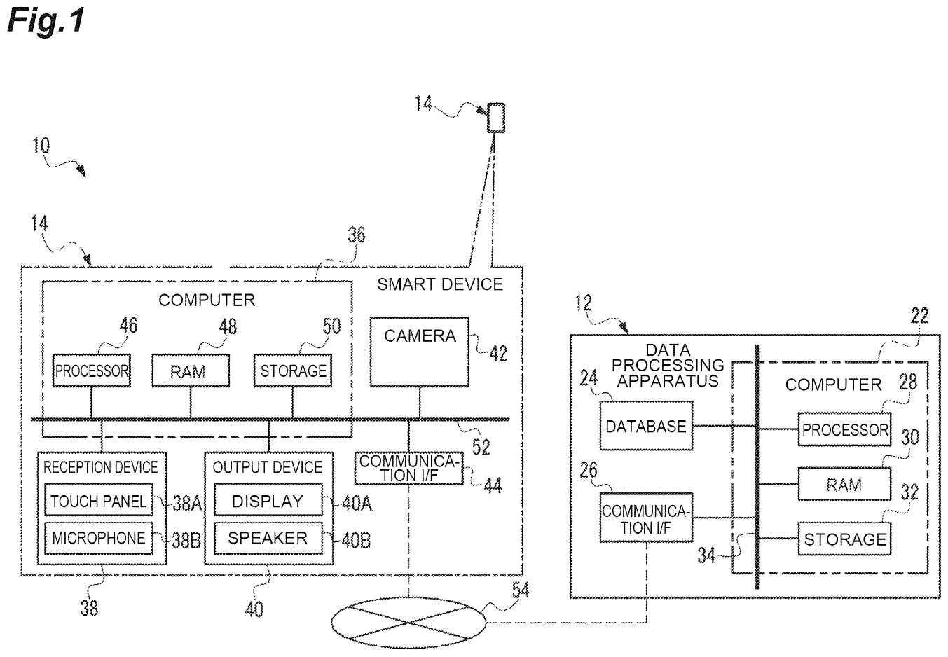

FIG. 1 illustrates an example of a configuration of a data processing system 10 according to a first embodiment.

As illustrated in FIG. 1, the data processing system 10 includes a data processing apparatus 12 and a smart device 14. An example of the data processing apparatus 12 includes a server.

The data processing apparatus 12 includes a computer 22, a database 24, and a communication I/F 26. The computer 22 is an example of a “computer” according to the technology of the present disclosure. The computer 22 includes a processor 28, a RAM 30, and a storage 32. The processor 28, the RAM 30, and the storage 32 are connected to a bus 34. Also, the database 24 and the communication I/F 26 are also connected to the bus 34. The communication I/F 26 is connected to a network 54. An example of the network 54 includes a WAN (Wide Area Network) and/or a LAN (Local Area Network), and the like.

The smart device 14 includes a computer 36, a reception device 38, an output device 40, a camera 42, and a communication I/F 44. The computer 36 includes a processor 46, a RAM 48, and a storage 50. The processor 46, the RAM 48, and the storage 50 are connected to a bus 52. Also, the reception device 38, the output device 40, and the camera 42 are also connected to the bus 52.

The reception device 38 includes a touch panel 38A, a microphone 38B, and the like, and receives a user input. The touch panel 38A receives a user input by contact of an indicator by detecting contact of the indicator (for example, a pen or a finger, etc.). The microphone 38B receives a user input by voice by detecting a user's voice. A control unit 46A transmits data indicating the user input received by the touch panel 38A and the microphone 38B to the data processing apparatus 12. In the data processing apparatus 12, a specific processing unit 290 acquires the data indicating the user input.

The output device 40 includes a display 40A, a speaker 40B, and the like, and presents data to a user 20 by outputting the data in a representation form (for example, voice and/or text) perceivable by the user 20. The display 40A displays visible information such as text and images in accordance with an instruction from the processor 46. The speaker 40B outputs voice in accordance with an instruction from the processor 46. The camera 42 is a small digital camera on which an optical system such as a lens, a diaphragm, and a shutter, and an image sensor such as a CMOS (Complementary Metal-Oxide-Semiconductor) image sensor or a CCD (Charge Coupled Device) image sensor are mounted.

The communication I/F 44 is connected to the network 54. The communication I/Fs 44 and 26 manage exchange of various information between the processor 46 and the processor 28 via the network 54.

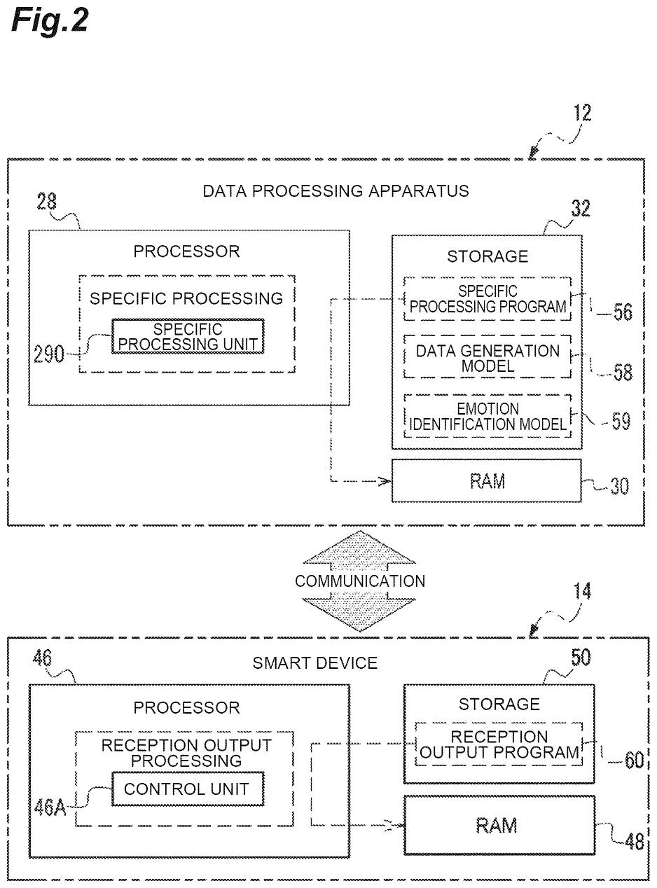

FIG. 2 illustrates an example of main functions of the data processing apparatus 12 and the smart device 14.

As illustrated in FIG. 2, in the data processing apparatus 12, specific processing is performed by the processor 28. A specific processing program 56 is stored in the storage 32. The specific processing program 56 is an example of a “program” according to the technology of the present disclosure. The processor 28 reads the specific processing program 56 from the storage 32 and executes the read specific processing program 56 on the RAM 30. The specific processing is realized by the processor 28 operating as a specific processing unit 290 in accordance with the specific processing program 56 executed on the RAM 30.

A data generation model 58 and an emotion identification model 59 are stored in the storage 32. The data generation model 58 and the emotion identification model 59 are used by the specific processing unit 290. The specific processing unit 290 can estimate a user's emotion using the emotion identification model 59 and perform specific processing using the user's emotion. In an emotion estimation function (emotion identification function) using the emotion identification model 59, various estimations and predictions regarding the user's emotion, including estimation and prediction of the user's emotion, are performed, but is not limited to such examples. Also, the estimation and prediction of emotion include, for example, analysis (analytics) of emotion and the like.

In the smart device 14, reception output processing is performed by the processor 46. A reception output program 60 is stored in the storage 50. The reception output program 60 is used in combination with the specific processing program 56 by the data processing system 10. The processor 46 reads the reception output program 60 from the storage 50 and executes the read reception output program 60 on the RAM 48. The specific processing is realized by the processor 46 operating as a control unit 46A in accordance with the reception output program 60 executed on the RAM 48. Note that the smart device 14 can also have a data generation model and an emotion identification model similar to the data generation model 58 and the emotion identification model 59, and perform processing similar to that of the specific processing unit 290 using these models. The reception output processing is realized by the processor 46 operating as the control unit 46A in accordance with the reception output program 60 executed on the RAM 48.

Note that an apparatus other than the data processing apparatus 12 may have the data generation model 58. For example, a server apparatus (for example, a generation server) may have the data generation model 58. In this case, the data processing apparatus 12 obtains a processing result (such as a prediction result) in which the data generation model 58 is used, by communicating with the server apparatus having the data generation model 58. Also, the data processing apparatus 12 may be a server apparatus, or may be a terminal device owned by a user (for example, a mobile phone, a robot, a home appliance, etc.). Next, an example of processing by the data processing system 10 according to the first embodiment will be described.

### Example 1.1

A flow of specific processing in Example 1.1 will be described. Each unit of the system described below is realized by the data processing apparatus 12 and the smart device 14. Also, the data processing apparatus 12 is referred to as a “server”, and the smart device 14 is referred to as a “terminal”.

This system is realized using a server and a terminal, and clarifies how the functions of each unit are shared.

First, the motion analysis unit is realized by the terminal. A user captures their own sports motion using a mobile terminal such as a smartphone or a tablet. This capturing targets various sports motions, such as, for example, a serve or forehand in tennis, a driver shot or putt in golf, pitching or batting in baseball, a floor exercise or vault in gymnastics, and a jazz dance or ballet step in dance. The terminal is equipped with a high-performance camera, which makes it possible to acquire high-resolution video. The captured video is analyzed using computer vision technology within the terminal, and detailed motion data including joint information for 200 locations is generated. For this analysis, for example, a skeleton recognition algorithm or a motion tracking technology is used to precisely digitize the user's motion by quantifying the position and movement trajectory of each joint.

The motion analysis unit may be configured to execute a lightweight neural network (e.g., a model using MobileNet or the like as a backbone) on an edge device such as a smartphone, extract only joint coordinate data from video data, and transmit the extracted data to a server. This produces a technical effect of reducing communication bandwidth by 90% or more compared to a case where high-resolution video data is transmitted as is, and reducing latency in a real-time feedback loop.

The motion analysis unit (realized by the processor 46 or 28) may use a Convolutional Neural Network (CNN) to generate heatmaps of respective joints and vector fields (Part Affinity Fields) between joints from an input image, and analyze these to identify 200 feature points. In this process, in order to maintain consistency of motion as time-series data, the processor may execute processing of estimating and complementing a joint position that has become invisible from the camera due to occlusion from preceding and succeeding frames using a Recurrent Neural Network (RNN) or Long Short-Term Memory (LSTM).

The motion analysis unit may have a function of detecting an “anomaly” from the acquired motion data. For example, when an angle exceeding a range of motion limit of a joint or an angular velocity having a risk of ligament damage is detected, the system may immediately generate a warning signal. This anomaly detection is determined based on a reconstruction error of an Autoencoder that has learned a distribution of normal motion data, and predicts danger faster and with higher accuracy than visual judgment by a human.

The motion data transmitted to the server may be transmitted not as an image itself but as coordinate vector data of joint points. At this time, personally identifiable information such as a background image or a user's face image may be discarded or masked on the device side. This makes it possible to safely integrate and use data from a plurality of users as learning data for machine learning in the data processing apparatus 12 while protecting privacy.

The motion analysis unit may be configured by, for example, the computer 36 (processor 46, etc.) and the camera 42 of the smart device 14, or may be configured by the control unit 46A, the reception output program 60, and the like.

Next, the ideal form generation unit is realized by the server. The motion data generated by the terminal is transmitted to the server using wireless communication technology. For this communication, for example, Wi-Fi or mobile data communication is used. The server generates an ideal form based on the received motion data, using the motion of a professional athlete as a benchmark. In this process, a motion database of professional athletes stored on the server is referenced. The database includes motion data of top athletes in each sport, such as, for example, the serve motion of a Grand Slam tennis champion, the swing of a major golf champion, the gymnastic performance of an Olympic athlete, and the steps of a professional dancer. The server compares the user's motion data with the data of these professional athletes and identifies points for improvement in the user's motion. For example, in a tennis swing, the trajectory of the racket, the timing of weight shift, the use of the wrist, and the like are analyzed to generate an ideal form. In a golf swing, the face angle of the club, the swing speed, and the rotation of the torso are analyzed.

The ideal form generation unit includes processing of normalizing (Retargeting) a difference between a skeletal length of the user and a skeletal length of the professional athlete. This is not a mere superimposition of video, but calculates a physically possible ideal trajectory within physical constraints of the user based on a kinematic chain, and is processing that is impossible to calculate by human mental activity.

In comparison processing in the ideal form generation unit, Dynamic Time Warping (DTW) may be used to non-linearly align a deviation in a time axis between the user's motion and the professional athlete's motion. This enables accurate form comparison for each phase even when motion speeds differ.

The ideal form generation unit may synthesize an “ideal form video with the user's own appearance” obtained by converting (Style Transfer) motion data of the professional athlete to match the user's physique (height, limb length) using a Generative Adversarial Network (GAN). This synthesis processing is executed at high speed by parallel operation by a GPU (Graphics Processing Unit) or an NPU (Neural Processing Unit) on the server side.

The ideal form generation unit may be configured by, for example, the computer 22 (processor 28, etc.) of the data processing apparatus 12, or may be configured by the specific processing unit 290, the specific processing program 56, the data generation model 58, and the like.

Finally, the projection display unit is realized by the terminal. The ideal form generated by the server is transmitted to the terminal again using wireless communication technology. The terminal visualizes the received ideal form as a virtual human motion. For this visualization, for example, augmented reality technology or 3D modeling technology is used to project the ideal motion in front of the user with projection technology. Through this projection, the user can visually confirm the ideal motion and directly compare it with their own motion. For example, in a gymnastic performance, an ideal posture and limb movements can be projected, and the user can adjust their motion accordingly. In dance steps, the rhythm and timing of the steps are visually indicated, enabling the user to accurately reproduce the motion.

The projection display unit may recognize a three-dimensional structure of a real space using SLAM (Simultaneous Localization and Mapping) technology, and correct distortion of a projected image according to a viewpoint position of the user. Thereby, the user obtains an Augmented Reality (AR) experience as if a real coach is in front of them through smart glasses or a projector.

When the system detects a “dangerous motion” such as an excessive load on the lumbar spine in the motion of the user (or caregiver), the projection display unit may highlight a target part in red and drive a vibration motor (Haptic Actuator) of the smart device 14 or a wearable device (not shown) to provide physical feedback. In a caregiving site, when it is determined that a fall risk is high, control may be performed to immediately transmit an alert (including location information and a motion log) to a terminal of a medical staff member or an administrator using a dedicated encryption protocol via the communication I/F 44.

The projection display unit may be configured by, for example, the computer 36 (processor 46, etc.) and the output device 40 (display 40A, speaker 40B, etc.) of the smart device 14, or may be configured by the control unit 46A, the reception output program 60, and the like.

Furthermore, this system also includes a function (a proposal unit) to configure and propose a practice menu according to individual needs based on the user's motion data. The server generates a practice menu including exercises for strengthening specific muscles, drills for improving the timing of motion, and the like, based on the user's motion analysis results. This practice menu is presented to the user through the terminal, and the user can obtain specific practice methods.

The proposal unit may be configured by, for example, the computer 22 (processor 28, etc.) of the data processing apparatus 12, or may be configured by the specific processing unit 290, the specific processing program 56, the data generation model 58, and the like.

In this way, by combining a server and a terminal, specific guidelines and means for a user to optimize motion and improve performance in sports are provided.

### (System Configuration)

The system includes a motion analysis unit, an ideal form generation unit, a projection display unit, a communication unit, a database unit, and a practice menu generation unit. The motion analysis unit has a function of analyzing a sports motion captured by a user using a mobile terminal such as a smartphone or a tablet. This analysis includes various sports motions, such as, for example, a serve in tennis, a swing in golf, batting in baseball, a performance in gymnastics, and steps in dance. The motion analysis unit acquires high-resolution video using a high-performance camera and generates detailed motion data including joint information for 200 locations by utilizing computer vision technology. This motion data precisely digitizes the user's motion by quantifying the position and movement trajectory of each joint using a skeleton recognition algorithm or a motion tracking technology.

The ideal form generation unit operates on a server and generates an ideal form based on the motion data generated by the motion analysis unit, using the motion of a professional athlete as a benchmark. In this generation process, a motion database of professional athletes stored on the server is referenced. The database includes motion data of top athletes in each sport, such as, for example, the serve motion of a Grand Slam tennis champion, the swing of a major golf champion, the gymnastic performance of an Olympic athlete, and the steps of a professional dancer. The ideal form generation unit compares the user's motion data with the data of the professional athlete and identifies points for improvement in the user's motion. For example, in a tennis swing, the trajectory of the racket, the timing of weight shift, the use of the wrist, and the like are analyzed to generate an ideal form. In a golf swing, the face angle of the club, the swing speed, and the rotation of the torso are analyzed.

The projection display unit operates on a terminal and visualizes the ideal form generated by the ideal form generation unit as a virtual human motion. For this visualization, augmented reality technology or 3D modeling technology is used to project the ideal motion in front of the user with projection technology. Through this projection, the user can visually confirm the ideal motion and directly compare it with their own motion. For example, in a gymnastic performance, an ideal posture and limb movements can be projected, and the user can adjust their motion accordingly. In dance steps, the rhythm and timing of the steps are visually indicated, enabling the user to accurately reproduce the motion.

The communication unit has a function of transmitting and receiving data between the terminal and the server. The motion data generated by the terminal is transmitted to the server using wireless communication technology. For this communication, Wi-Fi or mobile data communication is used. The ideal form generated by the server is also similarly transmitted to the terminal via the communication unit.

The database unit is arranged on the server and has a role of accumulating motion data of professional athletes. This database includes motion data of top athletes in each sport and is referenced when the ideal form generation unit generates an ideal form. The database is periodically updated, and new data of professional athletes is added, thereby always providing the latest motion information.

The practice menu generation unit operates on the server and configures and proposes a practice menu according to individual needs based on the user's motion data. This practice menu includes exercises for strengthening specific muscles, drills for improving the timing of motion, and the like. The generated practice menu is presented to the user through the terminal, and the user can obtain specific practice methods.

Specific examples of prompt sentences to be read into the generative AI include “Analyze the user's tennis serve motion and generate an ideal form by comparing it with a professional athlete's serve motion” and “Analyze the user's golf swing and identify points for improvement in the club trajectory and weight shift”. This enables the AI to analyze the user's motion in detail and present specific points for improvement.

### (Implementation Steps)

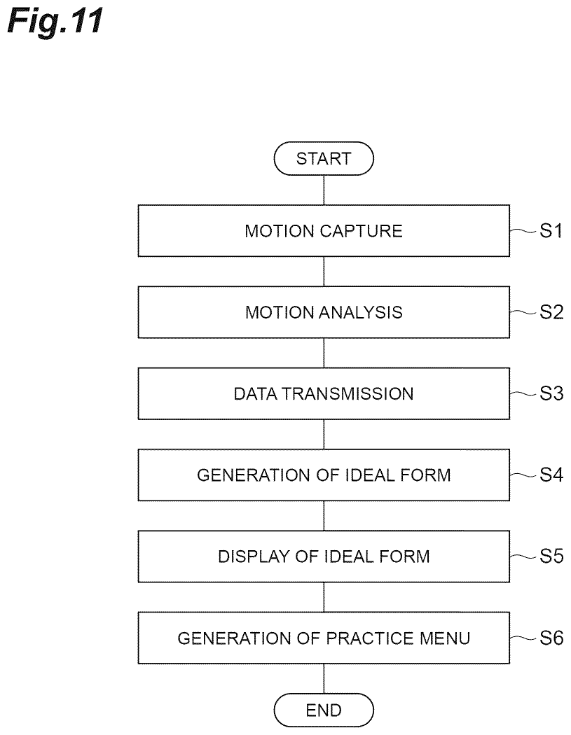

### Step 1: Motion Capture (Refer to Step S1 of FIG. 11)

A user captures their own sports motion using a mobile terminal such as a smartphone or a tablet. This capturing targets various sports motions, such as, for example, a serve in tennis, a swing in golf, batting in baseball, a performance in gymnastics, and steps in dance. The terminal is equipped with a high-performance camera, which makes it possible to acquire high-resolution video.

### Step 2: Motion Analysis (Refer to Step S2 of FIG. 11)

The captured video is analyzed using computer vision technology within the terminal, and detailed motion data including joint information for 200 locations is generated. For this analysis, a skeleton recognition algorithm or a motion tracking technology is used to precisely digitize the user's motion by quantifying the position and movement trajectory of each joint.

### Step 3: Data Transmission (Refer to Step S3 of FIG. 11)

The motion data generated by the terminal is transmitted to the server using wireless communication technology. For this communication, Wi-Fi or mobile data communication is used.

### Step 4: Ideal Form Generation (Refer to Step S4 of FIG. 11)

The server generates an ideal form based on the received motion data, using the motion of a professional athlete as a benchmark. In this process, a motion database of professional athletes stored on the server is referenced. Specific examples of prompt sentences to be read into the generative AI include “Analyze the user's tennis serve motion and generate an ideal form by comparing it with a professional athlete's serve motion” and “Analyze the user's golf swing and identify points for improvement in the club trajectory and weight shift”.

### Step 5: Ideal Form Display (Refer to Step S5 of FIG. 11)

The ideal form generated by the server is transmitted to the terminal again using wireless communication technology. The terminal visualizes the received ideal form as a virtual human motion. For this visualization, augmented reality technology or 3D modeling technology is used to project the ideal motion in front of the user with projection technology.

### Step 6: Practice Menu Generation (Refer to Step S6 of FIG. 11)

The server configures and proposes a practice menu according to individual needs based on the user's motion data. This practice menu includes exercises for strengthening specific muscles, drills for improving the timing of motion, and the like. The generated practice menu is presented to the user through the terminal, and the user can obtain specific practice methods.

### (Specific Use Case)

For example, consider a case where an athlete aiming to improve their tennis skills uses the system. This athlete captures their own serve motion using a smartphone. The captured video is analyzed by the motion analysis unit within the terminal, and detailed motion data including joint information for 200 locations is generated. This data is transmitted to the server using wireless communication technology.

The ideal form generation unit of the server generates an ideal form based on the received motion data, using the serve motion of a professional athlete as a benchmark. At this time, it references the motion database of professional athletes stored on the server and compares it with the user's motion data. A specific example of a prompt sentence to be read into the generative AI is “Analyze the user's tennis serve motion and generate an ideal form by comparing it with a professional athlete's serve motion”.

The generated ideal form is transmitted to the terminal again using wireless communication technology. The projection display unit of the terminal visualizes the received ideal form as a virtual human motion and projects it in front of the user. This visualization enables the athlete to visually confirm the ideal serve motion and directly compare it with their own motion.

Furthermore, the practice menu generation unit of the server configures and proposes a practice menu including exercises for strengthening specific muscles, drills for improving the timing of the serve, and the like, based on the user's motion data. This practice menu is presented to the user through the terminal, and the athlete can obtain specific practice methods.

In this way, specific guidelines and means for an athlete to optimize motion and improve performance in sports are provided.

### Example 1.2

A flow of specific processing in Application Example 1.2 will be described. Each unit of the system described below is realized by the data processing apparatus 12 and the smart device 14. Also, the data processing apparatus 12 is referred to as a “server”, and the smart device 14 is referred to as a “terminal”.

This system is designed to optimize a caregiver's motion and improve the quality of care, and includes a motion analysis unit, an ideal form generation unit, a projection display unit, a communication unit, a database unit, and a practice menu generation unit.

First, the motion analysis unit analyzes a caregiving motion captured by a caregiver using a smartphone or a tablet. This capturing targets various caregiving motions, such as, for example, a motion of transferring a patient from a bed to a wheelchair, a motion of changing the position of a bedridden patient, a motion of assisting a patient with difficulty walking, a motion of feeding a patient during a meal, and a motion of safely washing a patient during bathing. The terminal is equipped with a high-performance camera, which makes it possible to acquire high-resolution video. The captured video is analyzed using computer vision technology within the terminal, and detailed motion data including joint information for 200 locations is generated. For this analysis, a skeleton recognition algorithm or a motion tracking technology is used to precisely digitize the caregiver's motion by quantifying the position and movement trajectory of each joint.

Next, the ideal form generation unit operates on a server and generates an ideal caregiving motion based on the motion data generated by the motion analysis unit, using the motion of a professional caregiver as a benchmark. In this process, a motion database of professional caregivers stored on the server is referenced. The database includes optimal examples of various caregiving motions, such as, for example, the transfer technique of a veteran caregiver in a nursing home, the position change technique by a nurse in a hospital, the walking assistance technique in a rehabilitation facility, the optimal hand movements during meal assistance, and the safe way to support the body during bathing assistance. The ideal form generation unit compares the caregiver's motion data with the data of the professional caregiver and identifies points for improvement in the caregiver's motion. For example, in a patient transfer motion, it analyzes the ideal use of the body and application of force to generate an ideal form. In a position change, it generates an optimal motion for reducing the burden on the caregiver while ensuring the patient's safety.

The projection display unit operates on the terminal and visualizes the ideal caregiving motion generated by the ideal form generation unit as a virtual human motion. For this visualization, augmented reality technology or 3D modeling technology is used to project the ideal motion in front of the caregiver with projection technology. Through this projection, the caregiver can visually confirm the ideal caregiving motion and directly compare it with their own motion. For example, in a patient transfer motion, an ideal posture and limb movements can be projected, and the caregiver can adjust their motion accordingly. In walking assistance, it shows an ideal assistance motion for safely supporting the patient's walking, enabling the caregiver to accurately reproduce the motion.

The communication unit has a function of transmitting and receiving data between the terminal and the server. The motion data generated by the terminal is transmitted to the server using wireless communication technology. For this communication, Wi-Fi or mobile data communication is used. The ideal caregiving motion generated by the server is also similarly transmitted to the terminal via the communication unit.

The database unit is arranged on the server and has a role of accumulating motion data of professional caregivers. This database includes optimal examples of various caregiving motions and is referenced when the ideal form generation unit generates an ideal caregiving motion. The database is periodically updated, and new data of professional caregivers is added, thereby always providing the latest motion information.

The practice menu generation unit operates on the server and configures and proposes a practice menu according to individual needs based on the caregiver's motion data. This practice menu includes exercises for improving a specific motion, drills for improving caregiving skills, and the like. The generated practice menu is presented to the caregiver through the terminal, and the caregiver can obtain specific improvement methods. For example, it includes stretches to prevent back pain, strength training for safely lifting a patient, and practice for improving hand movements during meal assistance.

In this way, specific guidelines and means for a caregiver to optimize motion in caregiving and improve the quality of care are provided.

### (System Configuration)

The system includes a motion analysis unit, an ideal form generation unit, a projection display unit, a communication unit, a database unit, and a practice menu generation unit. The motion analysis unit has a function of analyzing a caregiving motion captured by a caregiver using a smartphone or a tablet. This analysis targets various caregiving motions, such as, for example, a motion of transferring a patient from a bed to a wheelchair, a motion of changing the position of a bedridden patient, a motion of assisting a patient with difficulty walking, a motion of feeding a patient during a meal, and a motion of safely washing a patient during bathing. The terminal is equipped with a high-performance camera, which makes it possible to acquire high-resolution video. The captured video is analyzed using computer vision technology within the terminal, and detailed motion data including joint information for 200 locations is generated. For this analysis, a skeleton recognition algorithm or a motion tracking technology is used to precisely digitize the caregiver's motion by quantifying the position and movement trajectory of each joint.

The ideal form generation unit operates on a server and generates an ideal caregiving motion based on the motion data generated by the motion analysis unit, using the motion of a professional caregiver as a benchmark. In this process, a motion database of professional caregivers stored on the server is referenced. The database includes optimal examples of various caregiving motions, such as, for example, the transfer technique of a veteran caregiver in a nursing home, the position change technique by a nurse in a hospital, the walking assistance technique in a rehabilitation facility, the optimal hand movements during meal assistance, and the safe way to support the body during bathing assistance. The ideal form generation unit compares the caregiver's motion data with the data of the professional caregiver and identifies points for improvement in the caregiver's motion. For example, in a patient transfer motion, it analyzes the ideal use of the body and application of force to generate an ideal form. In a position change, it generates an optimal motion for reducing the burden on the caregiver while ensuring the patient's safety. Specific examples of prompt sentences to be read into the generative AI include “Analyze the caregiver's transfer motion and generate an ideal form by comparing it with a professional caregiver's motion” and “Analyze the caregiver's position change technique and identify points for improvement”.

The projection display unit operates on the terminal and visualizes the ideal caregiving motion generated by the ideal form generation unit as a virtual human motion. For this visualization, augmented reality technology or 3D modeling technology is used to project the ideal motion in front of the caregiver with projection technology. Through this projection, the caregiver can visually confirm the ideal caregiving motion and directly compare it with their own motion. For example, in a patient transfer motion, an ideal posture and limb movements can be projected, and the caregiver can adjust their motion accordingly. In walking assistance, it shows an ideal assistance motion for safely supporting the patient's walking, enabling the caregiver to accurately reproduce the motion.

The communication unit has a function of transmitting and receiving data between the terminal and the server. The motion data generated by the terminal is transmitted to the server using wireless communication technology. For this communication, Wi-Fi or mobile data communication is used. The ideal caregiving motion generated by the server is also similarly transmitted to the terminal via the communication unit.

The database unit is arranged on the server and has a role of accumulating motion data of professional caregivers. This database includes optimal examples of various caregiving motions and is referenced when the ideal form generation unit generates an ideal caregiving motion. The database is periodically updated, and new data of professional caregivers is added, thereby always providing the latest motion information.

The practice menu generation unit operates on the server and configures and proposes a practice menu according to individual needs based on the caregiver's motion data. This practice menu includes exercises for improving a specific motion, drills for improving caregiving skills, and the like. The generated practice menu is presented to the caregiver through the terminal, and the caregiver can obtain specific improvement methods. For example, it includes stretches to prevent back pain, strength training for safely lifting a patient, and practice for improving hand movements during meal assistance.

In this way, the system provides specific guidelines and means for a caregiver to optimize motion in caregiving and improve the quality of care.

### (Implementation Steps)

### Step 1: Motion Capture

A caregiver captures their own caregiving motion using a smartphone or a tablet. This capturing targets various caregiving motions, such as a motion of transferring a patient from a bed to a wheelchair, a motion of changing the position of a bedridden patient, a motion of assisting a patient with difficulty walking, a motion of feeding a patient during a meal, and a motion of safely washing a patient during bathing. The terminal is equipped with a high-performance camera, making it possible to acquire high-resolution video.

### Step 2: Motion Analysis

The captured video is analyzed by the motion analysis unit within the terminal, and detailed motion data including joint information for 200 locations is generated. For this analysis, a skeleton recognition algorithm or a motion tracking technology is used to precisely digitize the caregiver's motion by quantifying the position and movement trajectory of each joint.

### Step 3: Data Transmission

The motion data generated by the terminal is transmitted to the server using wireless communication technology. For this communication, Wi-Fi or mobile data communication is used.

### Step 4: Ideal Form Generation

The ideal form generation unit of the server generates an ideal caregiving motion based on the received motion data, using the motion of a professional caregiver as a benchmark. In this process, a motion database of professional caregivers stored on the server is referenced. Specific examples of prompt sentences to be read into the generative AI include “Analyze the caregiver's transfer motion and generate an ideal form by comparing it with a professional caregiver's motion” and “Analyze the caregiver's position change technique and identify points for improvement”.

### Step 5: Ideal Form Display

The ideal caregiving motion generated by the server is transmitted to the terminal again using wireless communication technology. The projection display unit of the terminal visualizes the received ideal form as a virtual human motion and projects it in front of the caregiver. For this visualization, augmented reality technology or 3D modeling technology is used, enabling the caregiver to visually confirm the ideal caregiving motion and directly compare it with their own motion.

### Step 6: Practice Menu Generation

The practice menu generation unit of the server configures and proposes a practice menu including exercises for improving a specific motion, drills for improving caregiving skills, and the like, based on the caregiver's motion data. This practice menu is presented to the caregiver through the terminal, and the caregiver can obtain specific improvement methods. For example, it includes stretches to prevent back pain, strength training for safely lifting a patient, and practice for improving hand movements during meal assistance.

### (Specific Use Case)

For example, consider a case where the system is used in a nursing home to optimize a caregiver's motion of transferring a patient from a bed to a wheelchair. The caregiver captures their own transfer motion using a smartphone. This capturing is an important step for reducing the physical burden on the caregiver while ensuring the patient's safety. The captured video is analyzed by the motion analysis unit within the terminal, and detailed motion data including joint information for 200 locations is generated. This data is transmitted to the server using wireless communication technology.

The ideal form generation unit of the server generates an ideal transfer motion based on the received motion data, using the motion of a professional caregiver as a benchmark. In this process, a motion database of professional caregivers stored on the server is referenced. A specific example of a prompt sentence to be read into the generative AI is “Analyze the caregiver's transfer motion and generate an ideal form by comparing it with a professional caregiver's motion”. The generated ideal transfer motion is transmitted to the terminal again using wireless communication technology.

The projection display unit of the terminal visualizes the received ideal form as a virtual human motion and projects it in front of the caregiver. For this visualization, augmented reality technology or 3D modeling technology is used, enabling the caregiver to visually confirm the ideal transfer motion and directly compare it with their own motion. This allows the caregiver to visually understand the ideal posture and limb movements and adjust their motion.

Furthermore, the practice menu generation unit of the server configures and proposes a practice menu including exercises for improving a specific motion, drills for improving transfer skills, and the like, based on the caregiver's motion data. This practice menu is presented to the caregiver through the terminal, and the caregiver can obtain specific improvement methods. For example, it includes stretches to prevent back pain and strength training for safely lifting a patient.

In this way, specific guidelines and means for a caregiver to optimize motion in caregiving and improve the quality of care are provided.

The specific processing unit 290 transmits a result of the specific processing to the smart device 14. In the smart device 14, the control unit 46A causes the output device 40 to output the result of the specific processing. The microphone 38B acquires voice indicating a user input for the result of the specific processing. The control unit 46A transmits voice data indicating the user input acquired by the microphone 38B to the data processing apparatus 12. In the data processing apparatus 12, the specific processing unit 290 acquires the voice data.

The data generation model 58 is a so-called generative AI (Artificial Intelligence). An example of the data generation model 58 includes a generative AI such as ChatGPT (registered trademark) (Internet search <URL: https://openai.com/blog/chatgpt>). The data generation model 58 is obtained by causing a neural network to perform deep learning. A prompt including an instruction is input to the data generation model 58, and inference data such as voice data indicating voice, text data indicating text, and image data indicating an image (for example, still image data or moving image data) is input. The data generation model 58 infers the input inference data in accordance with the instruction indicated by the prompt, and outputs an inference result in one or more data formats among voice data, text data, image data, and the like. The data generation model 58 includes, for example, a text generation AI, an image generation AI, a multimodal generation AI, and the like. Here, inference refers to, for example, analysis, classification, prediction, and/or summarization, and the like. The specific processing unit 290 performs the above-described specific processing while using the data generation model 58. The data generation model 58 may be a model fine-tuned to output an inference result from a prompt that does not include an instruction, and in this case, the data generation model 58 can output an inference result from a prompt that does not include an instruction. In the data processing apparatus 12 and the like, a plurality of types of data generation models 58 are included, and the data generation model 58 includes AIs other than generative AI. AIs other than generative AI are, for example, linear regression, logistic regression, a decision tree, a random forest, a support vector machine (SVM), k-means clustering, a convolutional neural network (CNN), a recurrent neural network (RNN), a generative adversarial network (GAN), or naive Bayes, and can perform various processes, but is not limited to such examples. Also, the AI may be an AI agent. Also, when the processing of each unit described above is performed by an AI, the processing is partially or entirely performed by the AI, but is not limited to such examples. Also, a process implemented by an AI including a generative AI may be replaced with a rule-based process, and a rule-based process may be replaced with a process implemented by an AI including a generative AI.

Also, the processing by the data processing system 10 described above is executed by the specific processing unit 290 of the data processing apparatus 12 or the control unit 46A of the smart device 14, but may also be executed by the specific processing unit 290 of the data processing apparatus 12 and the control unit 46A of the smart device 14. Also, the specific processing unit 290 of the data processing apparatus 12 acquires or collects information necessary for the processing from the smart device 14 or an external device, and the smart device 14 acquires or collects information necessary for the processing from the data processing apparatus 12 or an external device.

For example, a collection unit is realized by the control unit 46A of the smart device 14 or the specific processing unit 290 of the data processing apparatus 12. For example, an acquisition unit acquires step count data using the camera 42 or the communication I/F 44 of the smart device 14, and the data is processed by the specific processing unit 290 of the data processing apparatus 12. For example, an analysis unit is realized by the specific processing unit 290 of the data processing apparatus 12, and analyzes data from the collection unit and the acquisition unit. For example, a generation unit is realized by the specific processing unit 290 of the data processing apparatus 12, and generates a cooking menu using a generative AI. For example, a provision unit is realized by the output device 40 of the smart device 14 or the specific processing unit 290 of the data processing apparatus 12, and provides the generated cooking menu to a user. The correspondence relationship between each unit and the device or the control unit is not limited to the above-described example, and various changes are possible.

An example form in which the specific processing is performed by the data processing apparatus 12 has been described, but the technology of the present disclosure is not limited to this, and the specific processing may be performed by the smart device 14.

### Second Embodiment

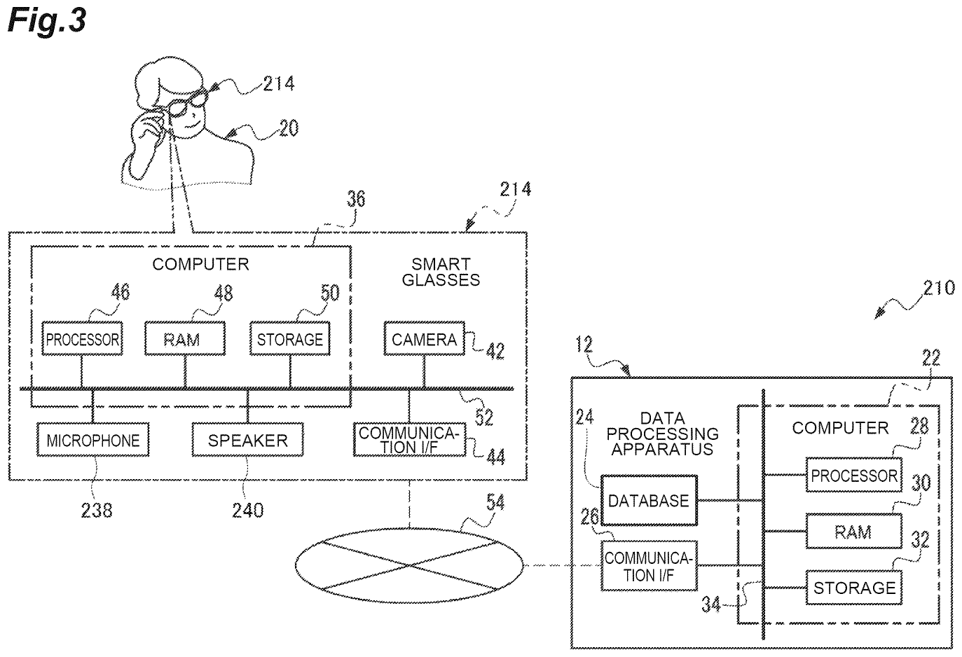

FIG. 3 illustrates an example of a configuration of a data processing system 210 according to a second embodiment.

As illustrated in FIG. 3, the data processing system 210 includes a data processing apparatus 12 and smart glasses 214. An example of the data processing apparatus 12 includes a server.

The data processing apparatus 12 includes a computer 22, a database 24, and a communication I/F 26. The computer 22 is an example of a “computer” according to the technology of the present disclosure. The computer 22 includes a processor 28, a RAM 30, and a storage 32. The processor 28, the RAM 30, and the storage 32 are connected to a bus 34. Also, the database 24 and the communication I/F 26 are also connected to the bus 34. The communication I/F 26 is connected to a network 54. An example of the network 54 includes a WAN (Wide Area Network) and/or a LAN (Local Area Network), and the like.

The smart glasses 214 include a computer 36, a microphone 238, a speaker 240, a camera 42, and a communication I/F 44. The computer 36 includes a processor 46, a RAM 48, and a storage 50. The processor 46, the RAM 48, and the storage 50 are connected to a bus 52. Also, the microphone 238, the speaker 240, and the camera 42 are also connected to the bus 52.

The microphone 238 receives an instruction or the like from a user 20 by receiving voice uttered by the user 20. The microphone 238 captures the voice uttered by the user 20, converts the captured voice into voice data, and outputs the voice data to the processor 46. The speaker 240 outputs voice in accordance with an instruction from the processor 46.

The camera 42 is a small digital camera on which an optical system such as a lens, a diaphragm, and a shutter, and an image sensor such as a CMOS (Complementary Metal-Oxide-Semiconductor) image sensor or a CCD (Charge Coupled Device) image sensor are mounted, and images the surroundings of the user 20 (for example, an imaging range defined by an angle of view corresponding to the width of the field of view of a general person with normal vision).

The communication I/F 44 is connected to the network 54. The communication I/Fs 44 and 26 manage exchange of various information between the processor 46 and the processor 28 via the network 54. The exchange of various information between the processor 46 and the processor 28 using the communication I/Fs 44 and 26 is performed in a secure state.

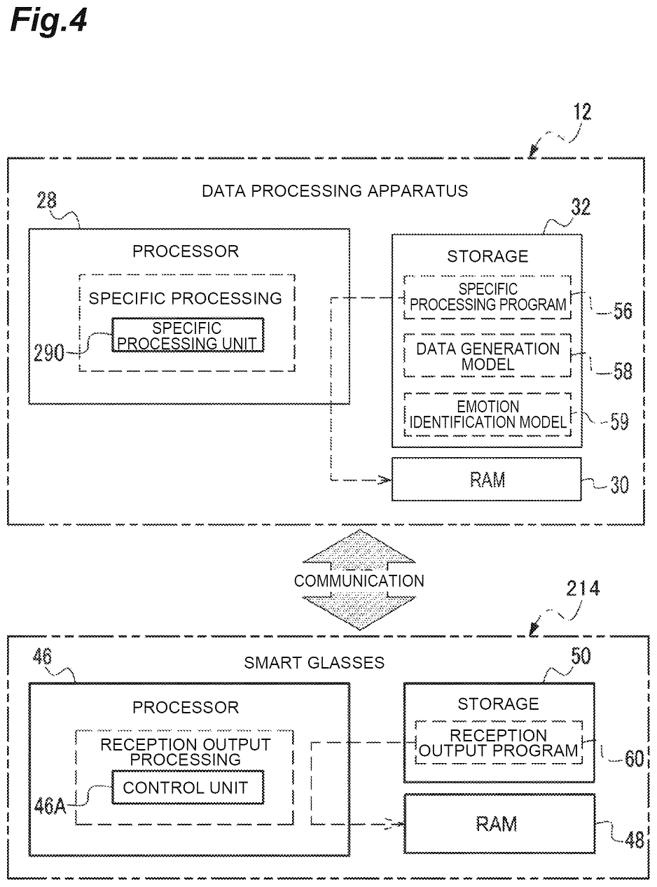

FIG. 4 illustrates an example of main functions of the data processing apparatus 12 and the smart glasses 214. As illustrated in FIG. 4, in the data processing apparatus 12, specific processing is performed by the processor 28. A specific processing program 56 is stored in the storage 32.

The specific processing program 56 is an example of a “program” according to the technology of the present disclosure. The processor 28 reads the specific processing program 56 from the storage 32 and executes the read specific processing program 56 on the RAM 30. The specific processing is realized by the processor 28 operating as a specific processing unit 290 in accordance with the specific processing program 56 executed on the RAM 30.

A data generation model 58 and an emotion identification model 59 are stored in the storage 32. The data generation model 58 and the emotion identification model 59 are used by the specific processing unit 290. The specific processing unit 290 can estimate a user's emotion using the emotion identification model 59 and perform specific processing using the user's emotion. In an emotion estimation function (emotion identification function) using the emotion identification model 59, various estimations and predictions regarding the user's emotion, including estimation and prediction of the user's emotion, are performed, but is not limited to such examples. Also, the estimation and prediction of emotion include, for example, analysis (analytics) of emotion and the like.

In the smart glasses 214, reception output processing is performed by the processor 46. A reception output program 60 is stored in the storage 50. The processor 46 reads the reception output program 60 from the storage 50 and executes the read reception output program 60 on the RAM 48. The reception output processing is realized by the processor 46 operating as a control unit 46A in accordance with the reception output program 60 executed on the RAM 48. Note that the smart glasses 214 can also have a data generation model and an emotion identification model similar to the data generation model 58 and the emotion identification model 59, and perform processing similar to that of the specific processing unit 290 using these models.

Next, specific processing by the specific processing unit 290 of the data processing apparatus 12 will be described. Each unit of the system described below is realized by the data processing apparatus 12 and the smart glasses 214. In the following description, the data processing apparatus 12 is referred to as a “server”, and the smart glasses 214 are referred to as a “terminal”.

### Example 2.1

Since the flow of the specific processing is the same as that in Example 1.1 described in the first embodiment, a description thereof is omitted.

### Example 2.2

Since the flow of the specific processing is the same as that in Example 1.2 described in the first embodiment, a description thereof is omitted.

The specific processing unit 290 transmits a result of the specific processing to the smart glasses 214. In the smart glasses 214, the control unit 46A causes the speaker 240 to output the result of the specific processing. The microphone 238 acquires voice indicating a user input for the result of the specific processing. The control unit 46A transmits voice data indicating the user input acquired by the microphone 238 to the data processing apparatus 12. In the data processing apparatus 12, the specific processing unit 290 acquires the voice data.

The data generation model 58 is a so-called generative AI (Artificial Intelligence). An example of the data generation model 58 includes a generative AI such as ChatGPT (registered trademark) (Internet search <URL: https://openai.com/blog/chatgpt>). The data generation model 58 is obtained by causing a neural network to perform deep learning. A prompt including an instruction is input to the data generation model 58, and inference data such as voice data indicating voice, text data indicating text, and image data indicating an image (for example, still image data or moving image data) is input. The data generation model 58 infers the input inference data in accordance with the instruction indicated by the prompt, and outputs an inference result in one or more data formats among voice data, text data, image data, and the like. The data generation model 58 includes, for example, a text generation AI, an image generation AI, a multimodal generation AI, and the like. Here, inference refers to, for example, analysis, classification, prediction, and/or summarization, and the like. The specific processing unit 290 performs the above-described specific processing while using the data generation model 58. The data generation model 58 may be a model fine-tuned to output an inference result from a prompt that does not include an instruction, and in this case, the data generation model 58 can output an inference result from a prompt that does not include an instruction. In the data processing apparatus 12 and the like, a plurality of types of data generation models 58 are included, and the data generation model 58 includes AIs other than generative AI. AIs other than generative AI are, for example, linear regression, logistic regression, a decision tree, a random forest, a support vector machine (SVM), k-means clustering, a convolutional neural network (CNN), a recurrent neural network (RNN), a generative adversarial network (GAN), or naive Bayes, and can perform various processes, but is not limited to such examples. Also, the AI may be an AI agent. Also, when the processing of each unit described above is performed by an AI, the processing is partially or entirely performed by the AI, but is not limited to such examples. Also, a process implemented by an AI including a generative AI may be replaced with a rule-based process, and a rule-based process may be replaced with a process implemented by an AI including a generative AI.

Also, the processing by the data processing system 10 described above is executed by the specific processing unit 290 of the data processing apparatus 12 or the control unit 46A of the smart device 14, but may also be executed by the specific processing unit 290 of the data processing apparatus 12 and the control unit 46A of the smart device 14. Also, the specific processing unit 290 of the data processing apparatus 12 acquires or collects information necessary for the processing from the smart device 14 or an external device, and the smart device 14 acquires or collects information necessary for the processing from the data processing apparatus 12 or an external device.

For example, a collection unit is realized by the control unit 46A of the smart device 14 or the specific processing unit 290 of the data processing apparatus 12. For example, an acquisition unit acquires step count data using the camera 42 or the communication I/F 44 of the smart device 14, and the data is processed by the specific processing unit 290 of the data processing apparatus 12. For example, an analysis unit is realized by the specific processing unit 290 of the data processing apparatus 12, and analyzes data from the collection unit and the acquisition unit. For example, a generation unit is realized by the specific processing unit 290 of the data processing apparatus 12, and generates a cooking menu using a generative AI. For example, a provision unit is realized by the output device 40 of the smart device 14 or the specific processing unit 290 of the data processing apparatus 12, and provides the generated cooking menu to a user. The correspondence relationship between each unit and the device or the control unit is not limited to the above-described example, and various changes are possible.

An example form in which the specific processing is performed by the data processing apparatus 12 has been described, but the technology of the present disclosure is not limited to this, and the specific processing may be performed by the smart glasses 214.

### Third Embodiment

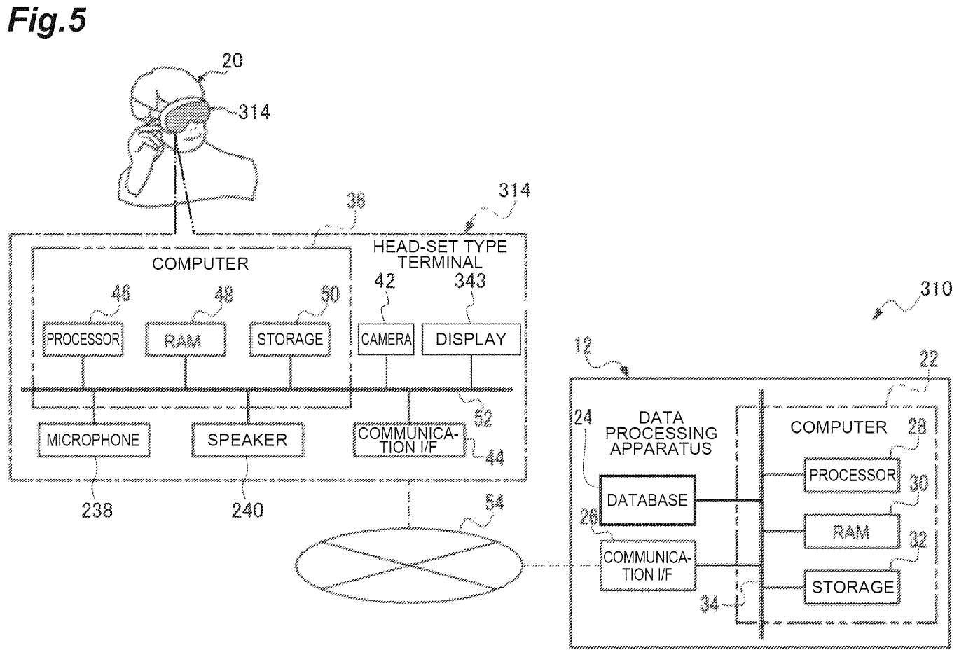

FIG. 5 illustrates an example of a configuration of a data processing system 310 according to a third embodiment.

As illustrated in FIG. 5, the data processing system 310 includes a data processing apparatus 12 and a headset-type terminal 314. An example of the data processing apparatus 12 includes a server.

The data processing apparatus 12 includes a computer 22, a database 24, and a communication I/F 26. The computer 22 is an example of a “computer” according to the technology of the present disclosure. The computer 22 includes a processor 28, a RAM 30, and a storage 32. The processor 28, the RAM 30, and the storage 32 are connected to a bus 34. Also, the database 24 and the communication I/F 26 are also connected to the bus 34. The communication I/F 26 is connected to a network 54. An example of the network 54 includes a WAN (Wide Area Network) and/or a LAN (Local Area Network), and the like.

The headset-type terminal 314 includes a computer 36, a microphone 238, a speaker 240, a camera 42, a communication I/F 44, and a display 343. The computer 36 includes a processor 46, a RAM 48, and a storage 50. The processor 46, the RAM 48, and the storage 50 are connected to a bus 52. Also, the microphone 238, the speaker 240, the camera 42, and the display 343 are also connected to the bus 52.

The microphone 238 receives an instruction or the like from a user 20 by receiving voice uttered by the user 20. The microphone 238 captures the voice uttered by the user 20, converts the captured voice into voice data, and outputs the voice data to the processor 46. The speaker 240 outputs voice in accordance with an instruction from the processor 46.

The camera 42 is a small digital camera on which an optical system such as a lens, a diaphragm, and a shutter, and an image sensor such as a CMOS (Complementary Metal-Oxide-Semiconductor) image sensor or a CCD (Charge Coupled Device) image sensor are mounted, and images the surroundings of the user 20 (for example, an imaging range defined by an angle of view corresponding to the width of the field of view of a general person with normal vision).

The communication I/F 44 is connected to the network 54. The communication I/Fs 44 and 26 manage exchange of various information between the processor 46 and the processor 28 via the network 54. The exchange of various information between the processor 46 and the processor 28 using the communication I/Fs 44 and 26 is performed in a secure state.

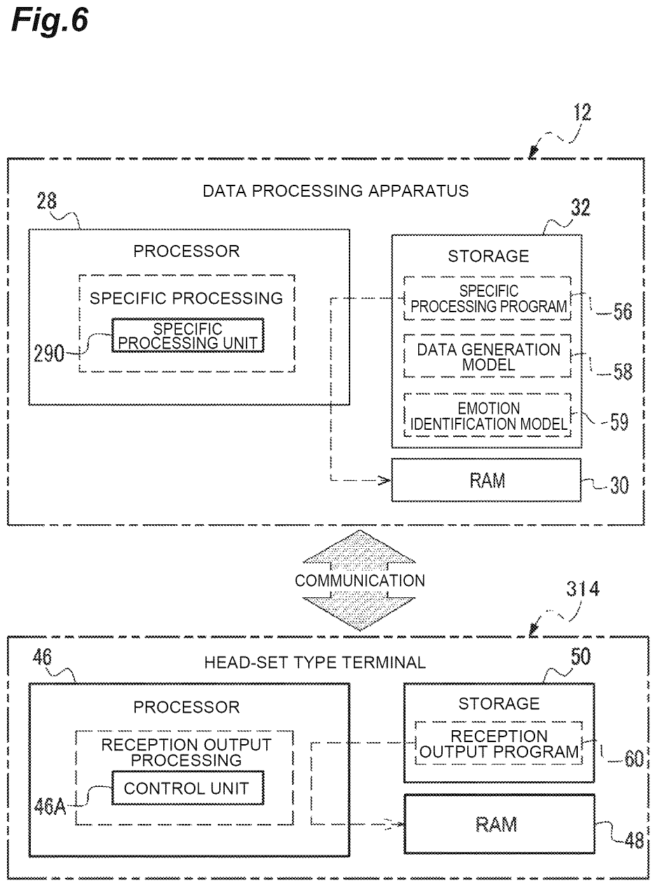

FIG. 6 illustrates an example of main functions of the data processing apparatus 12 and the headset-type terminal 314. As illustrated in FIG. 6, in the data processing apparatus 12, specific processing is performed by the processor 28. A specific processing program 56 is stored in the storage 32.

The specific processing program 56 is an example of a “program” according to the technology of the present disclosure. The processor 28 reads the specific processing program 56 from the storage 32 and executes the read specific processing program 56 on the RAM 30. The specific processing is realized by the processor 28 operating as a specific processing unit 290 in accordance with the specific processing program 56 executed on the RAM 30.

A data generation model 58 and an emotion identification model 59 are stored in the storage 32. The data generation model 58 and the emotion identification model 59 are used by the specific processing unit 290.

In the headset-type terminal 314, reception output processing is performed by the processor 46. A reception output program 60 is stored in the storage 50. The processor 46 reads the reception output program 60 from the storage 50 and executes the read reception output program 60 on the RAM 48. The reception output processing is realized by the processor 46 operating as a control unit 46A in accordance with the reception output program 60 executed on the RAM 48.

Next, specific processing by the specific processing unit 290 of the data processing apparatus 12 will be described. Each unit of the system described below is realized by the data processing apparatus 12 and the headset-type terminal 314. In the following description, the data processing apparatus 12 is referred to as a “server”, and the headset-type terminal 314 is referred to as a “terminal”.

### Example 3.1

Since the flow of the specific processing is the same as that in Example 1.1 described in the first embodiment, a description thereof is omitted.

### Example 3.2

Since the flow of the specific processing is the same as that in Example 1.2 described in the first embodiment, a description thereof is omitted.

The specific processing unit 290 transmits a result of the specific processing to the headset-type terminal 314. In the headset-type terminal 314, the control unit 46A causes the speaker 240 and the display 343 to output the result of the specific processing. The microphone 238 acquires voice indicating a user input for the result of the specific processing. The control unit 46A transmits voice data indicating the user input acquired by the microphone 238 to the data processing apparatus 12. In the data processing apparatus 12, the specific processing unit 290 acquires the voice data.

The data generation model 58 is a so-called generative AI (Artificial Intelligence). An example of the data generation model 58 includes a generative AI such as ChatGPT (registered trademark) (Internet search <URL: https://openai.com/blog/chatgpt>). The data generation model 58 is obtained by causing a neural network to perform deep learning. A prompt including an instruction is input to the data generation model 58, and inference data such as voice data indicating voice, text data indicating text, and image data indicating an image (for example, still image data or moving image data) is input. The data generation model 58 infers the input inference data in accordance with the instruction indicated by the prompt, and outputs an inference result in one or more data formats among voice data, text data, image data, and the like. The data generation model 58 includes, for example, a text generation AI, an image generation AI, a multimodal generation AI, and the like. Here, inference refers to, for example, analysis, classification, prediction, and/or summarization, and the like. The specific processing unit 290 performs the above-described specific processing while using the data generation model 58. The data generation model 58 may be a model fine-tuned to output an inference result from a prompt that does not include an instruction, and in this case, the data generation model 58 can output an inference result from a prompt that does not include an instruction. In the data processing apparatus 12 and the like, a plurality of types of data generation models 58 are included, and the data generation model 58 includes AIs other than generative AI. AIs other than generative AI are, for example, linear regression, logistic regression, a decision tree, a random forest, a support vector machine (SVM), k-means clustering, a convolutional neural network (CNN), a recurrent neural network (RNN), a generative adversarial network (GAN), or naive Bayes, and can perform various processes, but is not limited to such examples. Also, the AI may be an AI agent. Also, when the processing of each unit described above is performed by an AI, the processing is partially or entirely performed by the AI, but is not limited to such examples. Also, a process implemented by an AI including a generative AI may be replaced with a rule-based process, and a rule-based process may be replaced with a process implemented by an AI including a generative AI.

Also, the processing by the data processing system 10 described above is executed by the specific processing unit 290 of the data processing apparatus 12 or the control unit 46A of the smart device 14, but may also be executed by the specific processing unit 290 of the data processing apparatus 12 and the control unit 46A of the smart device 14. Also, the specific processing unit 290 of the data processing apparatus 12 acquires or collects information necessary for the processing from the smart device 14 or an external device, and the smart device 14 acquires or collects information necessary for the processing from the data processing apparatus 12 or an external device.

For example, a collection unit is realized by the control unit 46A of the smart device 14 or the specific processing unit 290 of the data processing apparatus 12. For example, an acquisition unit acquires step count data using the camera 42 or the communication I/F 44 of the smart device 14, and the data is processed by the specific processing unit 290 of the data processing apparatus 12. For example, an analysis unit is realized by the specific processing unit 290 of the data processing apparatus 12, and analyzes data from the collection unit and the acquisition unit. For example, a generation unit is realized by the specific processing unit 290 of the data processing apparatus 12, and generates a cooking menu using a generative AI. For example, a provision unit is realized by the output device 40 of the smart device 14 or the specific processing unit 290 of the data processing apparatus 12, and provides the generated cooking menu to a user. The correspondence relationship between each unit and the device or the control unit is not limited to the above-described example, and various changes are possible.

An example form in which the specific processing is performed by the data processing apparatus 12 has been described, but the technology of the present disclosure is not limited to this, and the specific processing may be performed by the headset-type terminal 314.

### Fourth Embodiment

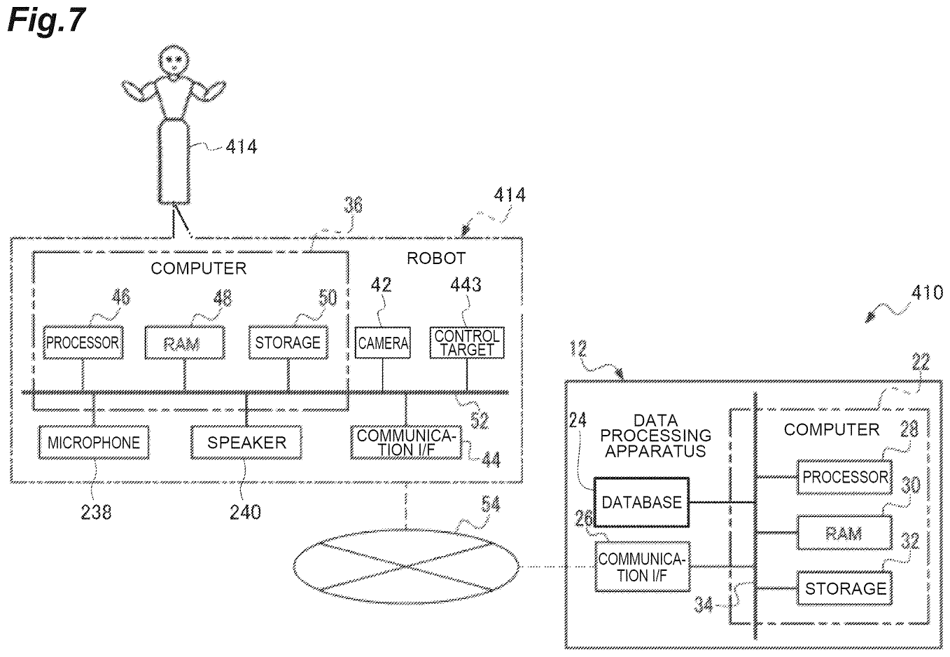

FIG. 7 illustrates an example of a configuration of a data processing system 410 according to a fourth embodiment.

As illustrated in FIG. 7, the data processing system 410 includes a data processing apparatus 12 and a robot 414. An example of the data processing apparatus 12 includes a server.

The data processing apparatus 12 includes a computer 22, a database 24, and a communication I/F 26. The computer 22 is an example of a “computer” according to the technology of the present disclosure. The computer 22 includes a processor 28, a RAM 30, and a storage 32. The processor 28, the RAM 30, and the storage 32 are connected to a bus 34. Also, the database 24 and the communication I/F 26 are also connected to the bus 34. The communication I/F 26 is connected to a network 54. An example of the network 54 includes a WAN (Wide Area Network) and/or a LAN (Local Area Network), and the like.

The robot 414 includes a computer 36, a microphone 238, a speaker 240, a camera 42, a communication I/F 44, and a control target 443. The computer 36 includes a processor 46, a RAM 48, and a storage 50. The processor 46, the RAM 48, and the storage 50 are connected to a bus 52. Also, the microphone 238, the speaker 240, the camera 42, and the control target 443 are also connected to the bus 52.

The microphone 238 receives an instruction or the like from a user 20 by receiving voice uttered by the user 20. The microphone 238 captures the voice uttered by the user 20, converts the captured voice into voice data, and outputs the voice data to the processor 46. The speaker 240 outputs voice in accordance with an instruction from the processor 46.

The camera 42 is a small digital camera on which an optical system such as a lens, a diaphragm, and a shutter, and an image sensor such as a CMOS (Complementary Metal-Oxide-Semiconductor) image sensor or a CCD (Charge Coupled Device) image sensor are mounted, and images the surroundings of the user 20 (for example, an imaging range defined by an angle of view corresponding to the width of the field of view of a general person with normal vision).

The communication I/F 44 is connected to the network 54. The communication I/Fs 44 and 26 manage exchange of various information between the processor 46 and the processor 28 via the network 54. The exchange of various information between the processor 46 and the processor 28 using the communication I/Fs 44 and 26 is performed in a secure state.

The control target 443 includes a display device, an LED of an eye part, and motors that drive an arm, a hand, a leg, and the like. The posture and gestures of the robot 414 are controlled by controlling the motors of the arm, hand, leg, and the like. A part of the emotions of the robot 414 can be expressed by controlling these motors. Also, the facial expression of the robot 414 can also be expressed by controlling the light emission state of the LED of the eye part of the robot 414.

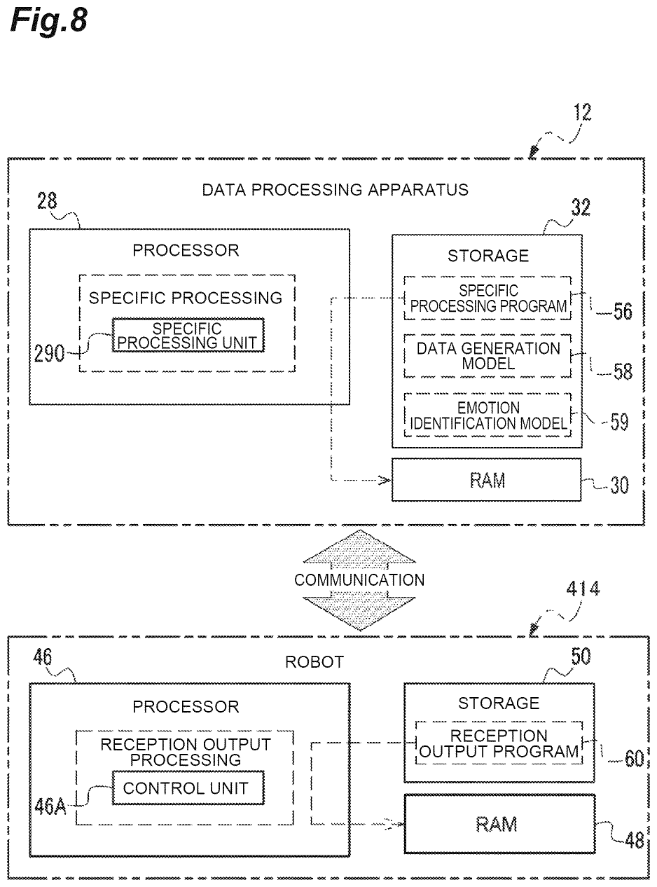

FIG. 8 illustrates an example of main functions of the data processing apparatus 12 and the robot 414. As illustrated in FIG. 8, in the data processing apparatus 12, specific processing is performed by the processor 28. A specific processing program 56 is stored in the storage 32.

The specific processing program 56 is an example of a “program” according to the technology of the present disclosure. The processor 28 reads the specific processing program 56 from the storage 32 and executes the read specific processing program 56 on the RAM 30. The specific processing is realized by the processor 28 operating as a specific processing unit 290 in accordance with the specific processing program 56 executed on the RAM 30.

A data generation model 58 and an emotion identification model 59 are stored in the storage 32. The data generation model 58 and the emotion identification model 59 are used by the specific processing unit 290.

In the robot 414, reception output processing is performed by the processor 46. A reception output program 60 is stored in the storage 50. The processor 46 reads the reception output program 60 from the storage 50 and executes the read reception output program 60 on the RAM 48. The reception output processing is realized by the processor 46 operating as a control unit 46A in accordance with the reception output program 60 executed on the RAM 48.

Next, specific processing by the specific processing unit 290 of the data processing apparatus 12 will be described. Each unit of the system described below is realized by the data processing apparatus 12 and the robot 414. In the following description, the data processing apparatus 12 is referred to as a “server”, and the robot 414 is referred to as a “terminal”.

### Example 4.1

Since the flow of the specific processing is the same as that in Example 1.1 described in the first embodiment, a description thereof is omitted.

### Example 4.2

Since the flow of the specific processing is the same as that in Example 1.2 described in the first embodiment, a description thereof is omitted.

The specific processing unit 290 transmits a result of the specific processing to the robot 414. In the robot 414, the control unit 46A causes the speaker 240 and the control target 443 to output the result of the specific processing. The microphone 238 acquires voice indicating a user input for the result of the specific processing. The control unit 46A transmits voice data indicating the user input acquired by the microphone 238 to the data processing apparatus 12. In the data processing apparatus 12, the specific processing unit 290 acquires the voice data.

The data generation model 58 is a so-called generative AI (Artificial Intelligence). An example of the data generation model 58 includes a generative AI such as ChatGPT (registered trademark) (Internet search <URL: https://openai.com/blog/chatgpt>). The data generation model 58 is obtained by causing a neural network to perform deep learning. A prompt including an instruction is input to the data generation model 58, and inference data such as voice data indicating voice, text data indicating text, and image data indicating an image (for example, still image data or moving image data) is input. The data generation model 58 infers the input inference data in accordance with the instruction indicated by the prompt, and outputs an inference result in one or more data formats among voice data, text data, image data, and the like. The data generation model 58 includes, for example, a text generation AI, an image generation AI, a multimodal generation AI, and the like. Here, inference refers to, for example, analysis, classification, prediction, and/or summarization, and the like. The specific processing unit 290 performs the above-described specific processing while using the data generation model 58. The data generation model 58 may be a model fine-tuned to output an inference result from a prompt that does not include an instruction, and in this case, the data generation model 58 can output an inference result from a prompt that does not include an instruction. In the data processing apparatus 12 and the like, a plurality of types of data generation models 58 are included, and the data generation model 58 includes AIs other than generative AI. AIs other than generative AI are, for example, linear regression, logistic regression, a decision tree, a random forest, a support vector machine (SVM), k-means clustering, a convolutional neural network (CNN), a recurrent neural network (RNN), a generative adversarial network (GAN), or naive Bayes, and can perform various processes, but is not limited to such examples. Also, the AI may be an AI agent. Also, when the processing of each unit described above is performed by an AI, the processing is partially or entirely performed by the AI, but is not limited to such examples. Also, a process implemented by an AI including a generative AI may be replaced with a rule-based process, and a rule-based process may be replaced with a process implemented by an AI including a generative AI.

Also, the processing by the data processing system 10 described above is executed by the specific processing unit 290 of the data processing apparatus 12 or the control unit 46A of the smart device 14, but may also be executed by the specific processing unit 290 of the data processing apparatus 12 and the control unit 46A of the smart device 14. Also, the specific processing unit 290 of the data processing apparatus 12 acquires or collects information necessary for the processing from the smart device 14 or an external device, and the smart device 14 acquires or collects information necessary for the processing from the data processing apparatus 12 or an external device.

For example, a collection unit is realized by the control unit 46A of the smart device 14 or the specific processing unit 290 of the data processing apparatus 12. For example, an acquisition unit acquires step count data using the camera 42 or the communication I/F 44 of the smart device 14, and the data is processed by the specific processing unit 290 of the data processing apparatus 12. For example, an analysis unit is realized by the specific processing unit 290 of the data processing apparatus 12, and analyzes data from the collection unit and the acquisition unit. For example, a generation unit is realized by the specific processing unit 290 of the data processing apparatus 12, and generates a cooking menu using a generative AI. For example, a provision unit is realized by the output device 40 of the smart device 14 or the specific processing unit 290 of the data processing apparatus 12, and provides the generated cooking menu to a user. The correspondence relationship between each unit and the device or the control unit is not limited to the above-described example, and various changes are possible.

An example form in which the specific processing is performed by the data processing apparatus 12 has been described, but the technology of the present disclosure is not limited to this, and the specific processing may be performed by the robot 414.

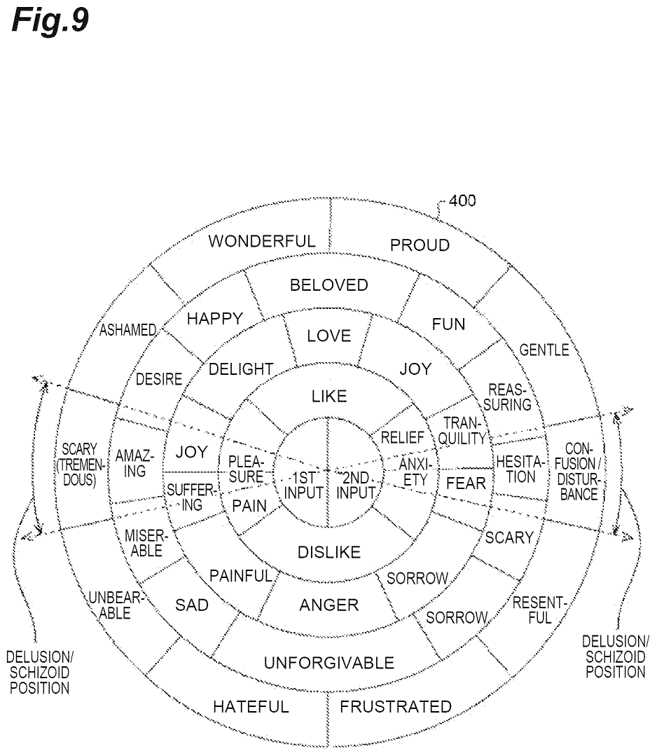

Note that the emotion identification model 59 as an emotion engine may determine a user's emotion according to a specific mapping. For example, the emotion identification model 59 may determine the user's emotion according to an emotion map (see FIG. 9), which is a specific mapping. Also, the emotion identification model 59 may similarly determine the robot's emotion, and the specific processing unit 290 may perform specific processing using the robot's emotion.

FIG. 9 is a diagram illustrating an emotion map 400 on which a plurality of emotions are mapped. In the emotion map 400, emotions are arranged in concentric circles radiating from the center. The closer to the center of the concentric circles, the more primitive the state of the emotion is arranged. On the outer side of the concentric circles, emotions representing states and actions arising from a state of mind are arranged. Emotion is a concept that also includes affect and mental states. On the left side of the concentric circles, emotions generated from reactions that generally occur in the brain are arranged. On the right side of the concentric circles, emotions that are generally induced by situational judgment are arranged. In the upward and downward directions of the concentric circles, emotions that are generated from reactions that generally occur in the brain and are induced by situational judgment are arranged. Also, on the upper side of the concentric circles, “pleasant” emotions are arranged, and on the lower side, “unpleasant” emotions are arranged. In this way, in the emotion map 400, a plurality of emotions are mapped based on the structure in which emotions are generated, and emotions that are likely to occur at the same time are mapped close to each other.

These emotions are distributed in the 3 o'clock direction of the emotion map 400, and usually go back and forth between relief and anxiety. In the right half of the emotion map 400, situational awareness is superior to internal sensations, resulting in a calm impression.

Since the inside of the emotion map 400 represents the inside of the mind and the outside of the emotion map 400 represents actions, the further one goes to the outside of the emotion map 400, the more visible (manifested in action) the emotion becomes.

Here, human emotions are based on various balances such as posture and blood sugar levels, and show a state of unpleasantness when those balances move away from the ideal, and a state of pleasantness when they approach the ideal. In robots, automobiles, motorcycles, and the like as well, emotions can be created based on various balances such as posture and remaining battery level, so as to show a state of unpleasantness when those balances move away from the ideal, and a state of pleasantness when they approach the ideal. The emotion map may be generated based on, for example, Dr. Mitsuyoshi's emotion map (Research on a speech emotion recognition and brain physiological signal analysis system of affect, Tokushima University, doctoral dissertation: https://ci.nii.ac.jp/naid/500000375379). In the left half of the emotion map, emotions belonging to a region called “reaction” where sensation is dominant are arranged. Also, in the right half of the emotion map, emotions belonging to a region called “situation” where situational awareness is dominant are arranged.

In the emotion map, two emotions that promote learning are defined. One is an emotion around the middle of negative “remorse” and “reflection” on the situation side. That is, it is when a negative emotion such as “I never want to feel this way again” or “I don't want to be scolded anymore” arises in the robot. The other is an emotion around positive “desire” on the reaction side. That is, it is when there is a positive feeling such as “I want more” or “I want to know more”.

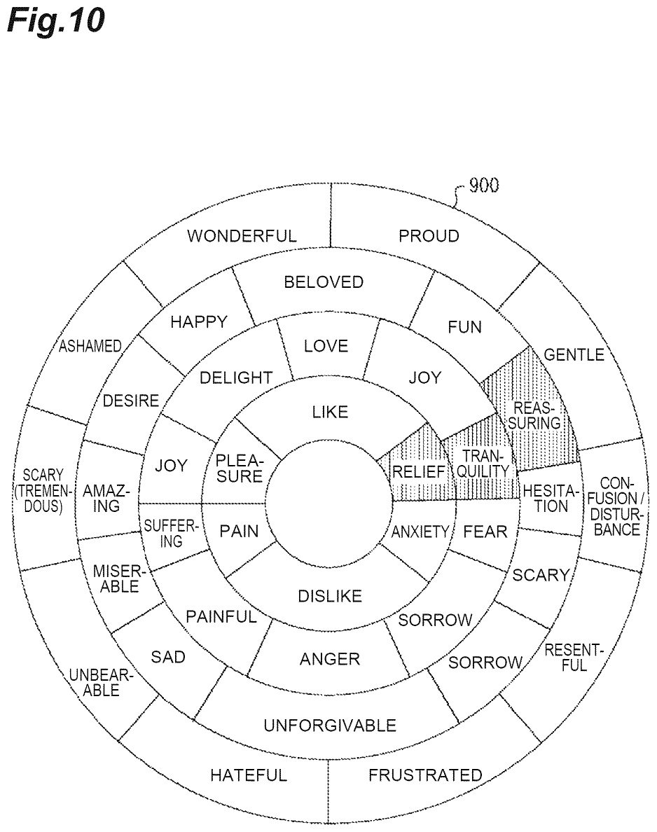

The emotion identification model 59 inputs a user input into a pre-trained neural network, acquires an emotion value indicating each emotion shown in the emotion map 400, and determines the user's emotion. This neural network is pre-trained based on a plurality of learning data that are combinations of user inputs and emotion values indicating each emotion shown in the emotion map 400. Also, this neural network is trained such that emotions arranged close to each other have close values, as in the emotion map 900 shown in FIG. 10. FIG. 10 shows an example in which a plurality of emotions, “relief,” “peace of mind,” and “reassured,” have close emotion values.

Although the system according to the present disclosure has been described above mainly with respect to the functions of the data processing apparatus 12, the system according to the present disclosure is not necessarily implemented in a server. The system according to the present disclosure may be implemented as a general information processing system. The present disclosure may be implemented as, for example, a software program that runs on a personal computer, or an application that runs on a smartphone or the like. The method according to the present disclosure may be provided to a user in a SaaS (Software as a Service) format.

An example form in which the specific processing is performed by one computer 22 has been described, but the technology of the present disclosure is not limited to this, and distributed processing for the specific processing may be performed by a plurality of computers including the computer 22. For example, the data generation model 58 may be provided in an external device of the data processing apparatus 12, and the external device may generate data according to the input data.

An example form in which the specific processing program 56 is stored in the storage 32 has been described, but the technology of the present disclosure is not limited to this. For example, the specific processing program 56 may be stored in a portable computer-readable non-transitory storage medium such as a USB (Universal Serial Bus) memory. The specific processing program 56 stored in the non-transitory storage medium is installed in the computer 22 of the data processing apparatus 12. The processor 28 executes the specific processing according to the specific processing program 56.

Also, the specific processing program 56 may be stored in a storage device such as a server connected to the data processing apparatus 12 via the network 54, and the specific processing program 56 may be downloaded in response to a request from the data processing apparatus 12 and installed in the computer 22.

Note that it is not necessary to store all of the specific processing program 56 in a storage device such as a server connected to the data processing apparatus 12 via the network 54, or to store all of the specific processing program 56 in the storage 32, and a part of the specific processing program 56 may be stored.

As hardware resources for executing the specific processing, various processors shown below can be used. Examples of the processor include a CPU, which is a general-purpose processor that functions as a hardware resource for executing the specific processing by executing software, that is, a program. Also, examples of the processor include a dedicated electric circuit, which is a processor having a circuit configuration specifically designed to execute specific processing, such as an FPGA (Field-Programmable Gate Array), a PLD (Programmable Logic Device), or an ASIC (Application Specific Integrated Circuit). A memory is built in or connected to any of the processors, and any of the processors executes the specific processing by using the memory.

The hardware resource that executes the specific processing may be configured by one of these various processors, or may be configured by a combination of two or more processors of the same type or different types (for example, a combination of a plurality of FPGAs, or a combination of a CPU and an FPGA). Also, the hardware resource that executes the specific processing may be one processor.

As an example of a configuration with one processor, first, there is a form in which one processor is configured by a combination of one or more CPUs and software, and this processor functions as a hardware resource for executing the specific processing. Second, there is a form in which a processor that realizes the functions of an entire system including a plurality of hardware resources for executing the specific processing with one IC chip, as represented by an SoC (System-on-a-chip) or the like, is used. In this way, the specific processing is realized using one or more of the various processors described above as hardware resources.

Furthermore, as a hardware structure of these various processors, an electric circuit in which circuit elements such as semiconductor elements are combined can be used. Also, the specific processing described above is merely an example. Therefore, it goes without saying that unnecessary steps may be deleted, new steps may be added, or the processing order may be changed within a scope that does not depart from the gist.

The description and illustrations shown above are detailed descriptions of the parts related to the technology of the present disclosure, and are merely an example of the technology of the present disclosure. For example, the description regarding the above-described configuration, function, operation, and effect is a description regarding an example of the configuration, function, operation, and effect of the part related to the technology of the present disclosure. Therefore, it goes without saying that unnecessary parts may be deleted, new elements may be added, or replacements may be made to the description and illustrations shown above within a scope that does not depart from the gist of the technology of the present disclosure. Also, in order to avoid confusion and facilitate understanding of the parts related to the technology of the present disclosure, in the description and illustrations shown above, descriptions regarding common general technical knowledge and the like that do not require particular explanation for enabling the implementation of the technology of the present disclosure are omitted.

All documents, patent applications, and technical standards described in this specification are incorporated herein by reference to the same extent as if each individual document, patent application, and technical standard were specifically and individually indicated to be incorporated by reference.

It is to be understood that not all aspects, advantages and features described herein may necessarily be achieved by, or included in, any one particular example. Indeed, having described and illustrated various examples herein, it should be apparent that other examples may be modified in arrangement and detail.

A system including a motion analysis unit, an ideal form generation unit, and a projection display unit. The motion analysis unit analyzes a caregiving motion captured by a caregiver using a smartphone or a tablet and generates detailed motion data including joint information for 200 locations. The ideal form generation unit generates an ideal caregiving motion based on the motion data obtained by the motion analysis unit, using the motion of a professional caregiver as a benchmark. The projection display unit visualizes the ideal caregiving motion generated by the ideal form generation unit as a virtual human motion and projects it in front of the caregiver. This allows the caregiver to compare their own motion with the ideal form and visually confirm points for improvement.

In some examples, the motion analysis unit precisely digitizes the caregiver's motion by analyzing the caregiver's motion in detail and quantifying the position and movement trajectory of each joint. This allows the caregiver's motion data to provide high-precision information necessary for analysis by the ideal form generation unit and contributes to the generation of an ideal caregiving motion.

In some examples, the ideal form generation unit compares the caregiver's motion data with the motion data of a professional caregiver, identifies points for improvement in the caregiver's motion, and generates a plurality of ideal forms. Furthermore, based on the generated ideal form, it configures and proposes a practice menu for the caregiver to learn the ideal caregiving motion. This allows the caregiver to obtain specific practice methods and can improve the quality of care.

An example system for evaluating motion in sports may include circuitry. The circuitry may be configured to: generate motion data based on a captured video of a sports motion of a user; generate an ideal form based on the motion data using a motion of a professional athlete as a benchmark; and visualize the generated ideal as a virtual human motion.

In some examples, generating the motion data may include generating the motion data by analyzing the motion of the user and quantifying a position and a movement trajectory of a joint of the user.

In some examples, generating the ideal form may include: comparing the motion data of the user with the motion data of the professional athlete; identifying a point for improvement in the motion of the user; and generating a plurality of ideal forms.

In some examples, the circuitry may be further configured to generate a practice menu for the user to learn an ideal caregiving motion based on the generated ideal form.

An example method for evaluating motion in sports may include: generating motion data based on a captured video of a sports motion of a user; generating an ideal form based on the motion data using a motion of a professional athlete as a benchmark; and visualizing the generated ideal form as a virtual human motion.

What is claimed is:

1. A system for evaluating motion in sports, the system comprising circuitry,
wherein the circuitry is configured to:
generate motion data based on a captured video of a sports motion of a user;
generate an ideal form based on the motion data using a motion of a professional athlete as a benchmark; and
visualize the generated ideal as a virtual human motion.

2. The system according to claim 1, wherein generating the motion data includes generating the motion data by analyzing the motion of the user and quantifying a position and a movement trajectory of a joint of the user.

3. The system according to claim 1, wherein generating the ideal form includes:
comparing the motion data of the user with the motion data of the professional athlete;
identifying a point for improvement in the motion of the user; and
generating a plurality of ideal forms.

4. The system according to claim 1, wherein the circuitry is further configured to generate a practice menu for the user to learn an ideal caregiving motion based on the generated ideal form.

5. A method for evaluating motion in sports, the method comprising:
generating motion data based on a captured video of a sports motion of a user;
generating an ideal form based on the motion data using a motion of a professional athlete as a benchmark; and
visualizing the generated ideal form as a virtual human motion.
